(19) United States
(12) Patent Application Publication
(10) Pub. No.: US 2016/0127496 A1
(43) Pub. Date: May 5, 2016

(54) METHOD AND SYSTEM OF CONTENT CACHING AND TRANSMISSION

(71) Applicant: Alibaba Group Holding Limited, Grand Cayman (KY)

(72) Inventor: Wei Zhang, Hangzhou (CN)

(21) Appl. No.: 14/927,386

(22) Filed: Oct. 29, 2015

(30) Foreign Application Priority Data
Oct. 30, 2014 (CN) 201410605647.7

(51) Int. Cl. H04L 29/08; H04L 29/06

(52) U.S. Cl. CPC H04L 67/2842; H04L 67/42; H04L 67/10; H04L 67/306

(57) ABSTRACT

A content caching and transmission method and a system thereof are disclosed. In the method, a client side returns only identifiers that are cached by the client to a server when a new page is to be displayed, and the server directly obtains content of a content queue based on the identifiers to cause the client to display the content corresponding to the identifiers without the need of performing ordering and computations repeatedly, thus saving traffic and caching resources, reducing data transmitted between the client and the server, improving user experience with respect to a browsing speed, and facilitating expansion in face of an increase in the number of users.

### CROSS REFERENCE TO RELATED PATENT APPLICATION

This application claims foreign priority to Chinese Patent Application No. 201410605647.7 filed on Oct. 30, 2014, entitled “Method and System of Content Caching and Transmission”, which is hereby incorporated by reference in its entirety.

### TECHNICAL FIELD

The present disclosure relates to data caching and transmission technologies, and particularly, to methods and systems of content caching and transmission.

### BACKGROUND

Usually, in an Internet social system, a user may follow X number of public accounts, and each public account may release Y pieces of content. A Timeline corresponds to dynamic streams or content streams of the accounts that are followed by the user and that are ordered according to conditions such as time and displayed in a stream-like form after integration, which also supports scrolling down of pages. When the user requests content data released by the followed public accounts in the Timeline, a server needs to obtain data from a plurality of K/V cache service clusters, process X*Y pieces of content in total, and select the latest M pieces of content data for the Timeline to display. Each time when a request from a client end is received, the server returns only one page that includes N pieces of content. Since the number of users is generally tremendous, respective lists of accounts that each user follows are different and content queues that generate corresponding Timelines are different, caching these content queues of the Timelines needs a relatively large storage space, and thus data of these content queues cannot be stored in a cache of the server.

Since data of a Timeline is generally not cached, each time when a user requests the data of the Timeline, a server needs to perform a process of “obtaining a list of accounts that the user follows→obtaining a content queue of content (i.e., X*Y pieces of content) sent by the accounts that the user follows→ordering the X*Y pieces of content according to the Timeline→obtaining complete real-time data of content of the Timeline”, which results in a high overhead for ordering or caching by a Central Processing Unit (CPU).

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “techniques,” for instance, may refer to device(s), system(s), method(s) and/or computer-readable instructions as permitted by the context above and throughout the present disclosure.

The present disclosure provides a method and a system of caching and transmitting content, to save transmission and caching resources, improve a browsing speed of a user and facilitate extension.

In order to solve the foregoing technical problems, implementations of the present disclosure disclose a content caching and transmission method. A content queue includes at least one piece of content, with each piece of content including an identifier and a value and the identifier being unique in the content queue. In an example method implementation, a server obtains a content queue, and sends identifiers of M pieces of content in the content queue to a client, where M is a predefined integer. The client caches the received M identifiers. The client selects N identifiers from the cached M identifiers when the client needs to display a new page of N pieces of new content, where N<M, and sends the selected N identifiers to the server. The server obtains the corresponding N pieces of new content based on the received N identifiers, and returns the corresponding N pieces of new content to the client for display.

The implementations of the present disclosure further disclose a content caching and transmission system, in which a content queue includes at least one piece of content, each piece of content includes an identifier and a value, and the identifier is unique in the content queue. In implementations, the system may include a server and a client.

In implementations, the server may include a first sending module to obtain a content queue, and send identifiers of M pieces of content in the content queue to the client, where M is a predefined integer; and a feedback module to obtain corresponding N pieces of new content based on N identifiers received from the client, and return the corresponding N pieces of new content to the client for display.

In implementations, the client side may include a caching module to cache M identifiers received from the server; a selection module to select the N identifiers from the cached M identifiers when a new page of the N pieces of new content is to be displayed, where N<M; and a second sending module to send the selected N identifiers to the server.

The implementations of the present disclosure further disclose a content caching and transmission method, in which a content queue includes at least one piece of content, each piece of content includes an identifier and a value, and the identifier is unique in the content queue. In an example method implementation, a server obtains a content queue, and sends identifiers of M pieces of content in the content queue to a client to enable the client to cache the received M identifiers, select N identifiers from the cached M identifiers when a new page of N pieces of new content needs to be displayed, and send the selected N identifiers to the server, where M is a predefined integer, and N<M. The server obtains the corresponding N pieces of new content based on the received N identifiers, and returns corresponding N pieces of new content to the client for display.

The implementations of the present disclosure further disclose a content caching and transmission method, in which a content queue includes at least one piece of content, each piece of content includes an identifier and a value, and the identifier is unique in the content queue. In an example method implementation, a client receives and caches M identifiers of M pieces of content that a server obtains from a content queue. M is a predefined integer. When a new page of N pieces of new content needs to be displayed, the client selects N identifiers from the cached M identifiers, where N<M. The client sends the selected N identifiers to the server to enable the server to obtain the corresponding N pieces of new content based on the received N identifiers and return the corresponding N pieces of new content to the client for display.

The implementations of the present disclosure further disclose a content caching and transmission system, in which a content queue includes at least one piece of content, each piece of content includes an identifier and a value, and the identifier is unique in the content queue. In implementations, the system may include a server. In implementations, the server may include a first sending module configured to obtain a content queue, and send identifiers of M pieces of content in the content queue to the client to enable the client side to cache the received M identifiers, select N identifiers from the cached M identifiers when a new page of N pieces of new content needs to be displayed, and send the selected N identifiers to the server, where M is a predefined integer, and N<M; and a feedback module configured to obtain the corresponding N pieces of new content based on the N identifiers received from the client and return the corresponding N pieces of new content to the client for display.

The implementations of the present disclosure further disclose a content caching and transmission system, in which a content queue includes at least one piece of content, each piece of content includes an identifier and a value, and the identifier is unique in the content queue. In implementations, the system may include a client. The client side may include a caching module configured to receive and cache M identifiers of M pieces of content that a server obtains from a content queue, where M is a predefined integer; a selection module configured to select N identifiers from the cached M identifiers when a new page of N pieces of new content needs to be displayed, where N<M; and a second sending module configured to send the selected N identifiers to the server to cause the server to obtain the corresponding N pieces of new content based on the received N identifiers and return the corresponding N pieces of new content to the client for display.

Compared with existing technologies, the implementations of the present disclosure have the following differences and effects.

In the present disclosure, when a new page needs to be displayed, a client only needs to return corresponding identifiers cached by the client to a server. The server may directly obtain content of a content queue based on the identifiers for the client to display without the need of repeating ordering and computation, thus saving transmission and caching resources, reducing data transmitted between the client and the server, improving user experience in terms of browsing speed, and facilitating expansion in response to an increasing number of users.

Furthermore, extracting a minimal amount of identification information from content of a content queue and caching this information in a client can assist a server in sharing resource pressure.

Furthermore, different types of content queues may be obtained according to customer needs.

### BRIEF DESCRIPTION OF THE DRAWINGS

FIG. 1 is a flowchart of a content caching and transmission method according to a first embodiment of the present disclosure.

FIG. 2 is a flowchart of sending identifiers in a content caching and transmission method according to the first embodiment of the present disclosure.

FIG. 3 is a flowchart of interaction between a client and a server according to a second embodiment of the present disclosure.

FIG. 4 is a flowchart of interaction between a client and a server according to the second embodiment of the present disclosure.

FIG. 5 is a structural diagram of a content caching and transmission system according to a third embodiment of the present disclosure.

FIG. 6 is a structural diagram of a first sending module in a content caching and transmission system according to the third embodiment of the present disclosure.

FIG. 7 is a structural diagram of the example apparatus as described in FIGS. 3-5 in further detail.

### DETAILED DESCRIPTION

A number of technical details are provided herein to facilitate understanding of the present disclosure by readers. However, one of ordinary skill in the art should understand that technical solutions described in the appended claims of the present disclosure can be implemented even without these technical details and that technical solutions can be implemented based on various changes and modifications to each implementation described herein.

In order to make the objectives, technical solutions and advantages of the present disclosure more clear, embodiments of the present disclosure are described herein with reference to accompanying drawings.

It is worth noting that an order of content is basically stable during a process of refreshing a content queue by a user. As such, a solution is needed to cache key information of this content queue. The key information of the content queue is very small in size, and may be better to be stored outside a server. When the user scrolls down a page, the server directly returns content based on the key information, thus saving computing and storage resources. In particular, user personalized data that has been processed and simplified may be cached completely inside an APP to assist the server in sharing the pressure on resources when combining with characteristics of wireless applications.

Therefore, identifiers of M pieces of latest content in the content queue are cached in a client. In a process of scrolling down a page, the client locally selects N identifiers and requests the server to obtain a new page of content that is actually to be displayed. The server directly obtains a page of N pieces of content from a cache based on the selected N identifiers, thus saving resources associated with the traffic and the cache and further avoiding repeated ordering and computation.

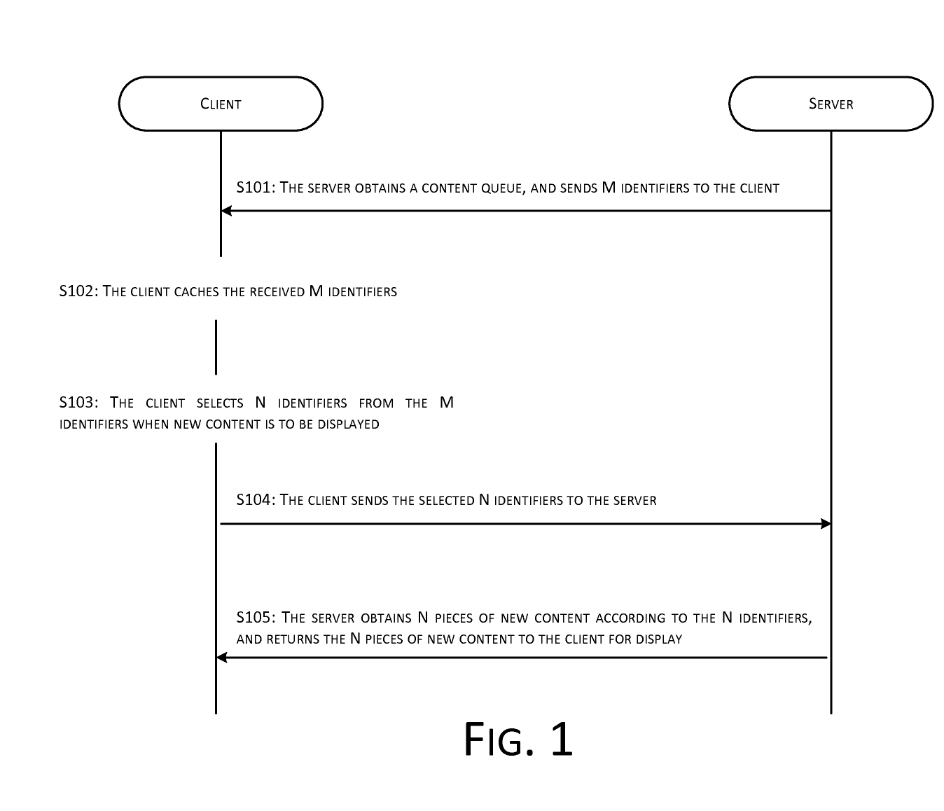

A first embodiment of the present disclosure is related to a content caching and transmission method. FIG. 1 is a flowchart of the content caching and transmission method. A content queue includes at least one piece of content. Each piece of content includes an identifier and a value, with the identifier being unique in the content queue. It should be understood that a content queue is typically a list. The value described in various implementations of the present disclosure is data in general, and does not specifically refer to a numerical value. The value may be, for example, a numerical value, a character string, a letter, a date, a time, a Boolean value or a data structure, etc.

As shown in FIG. 1, the method may include the following method blocks.

At S101, a server obtains a content queue, and sends identifiers of M pieces of content in the content queue to a client, in which M is a predefined integer. In an exemplary embodiment, M is generally the maximum number of pieces of content to be displayed in the content queue. The entire content queue may have many pieces of content, for example, a few thousands of pieces of content, or even tens of thousands of pieces of content. However, a user generally does not read so many pieces of content and usually reads dozens or hundreds of pieces of latest content. M may be 100, 250, 488, etc. For example, upon investigation, most users are found to read hundreds of pieces of content at most in an electronic commerce application, and M may be 500 at this point.

In addition, it can be understood that the identifiers may be assigned to respective pieces of content in the content queue in advance. The identifiers uniquely map respective pieces of content in the content queue.

As an alternative implementation, the server obtains a content queue when a client requests content of the content queue for the first time, when an associated cache is invalidated or at any other times, and sends identifiers of M pieces of content in the content queue to the client. The cache invalidation may include situations such as the client updating the M pieces of content, changing a user account or altering all accounts that have been followed, etc.

At S102, the client caches the received M identifiers. In implementations, the cached M identifiers may be ordered according to respective times, and respective pieces of content displayed in this manner may also be ordered according to times. It should be understood that, the cached M identifiers may also be ordered based on other information according to user needs, for example, respective numbers of replies, respective amounts of page views, etc., in other implementations of the present disclosure.

In an exemplary embodiment, the client may include an application (APP) on a mobile terminal. In another embodiment, the client may include software on a desktop computer. In some application scenarios, the client may alternatively include a specialized special-purpose terminal, etc.

At S103, the client selects N identifiers from the cached M identifiers when a new page of N pieces of new content needs to be displayed, with N<M. It can be understood that the client may select the N identifiers based on corresponding content that is displayed in a current page, for example, the first piece or the final piece of content in the current page or any piece of content therein.

At S104, the client sends the selected N identifiers to the server.

At S105, the server obtains the corresponding N pieces of new content based on the received N identifiers, and returns the corresponding N pieces of new content to the client for display.

The process ends thereafter.

In this embodiment, the client only needs to return corresponding identifiers cached by the client to the server when a new page needs to be displayed. The server may directly obtain content of a content queue based on the identifiers for the client to display without the need of ordering and computation repeatedly, thus saving transmission and caching resources, reducing data transmitted between the client and the server, improving user experience in terms of browsing speed, and facilitating expansion in response to an increase in the number of users.

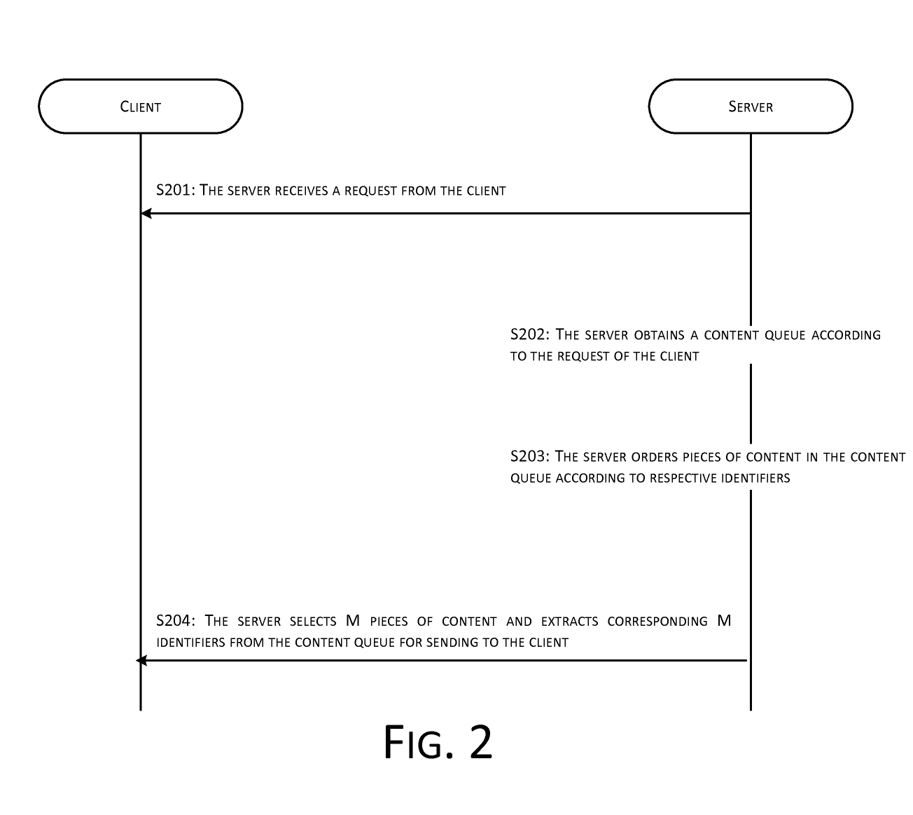

In an exemplary implementation, S101 may include the following method sub-blocks as shown in FIG. 2.

At S201, the server receives a request from the client.

At S202, the server obtains the content queue according to the request of the client, the content queue including pieces of content of all accounts that the client follows.

At S203, the server orders the pieces of content in the content queue according to identifiers. In implementations, the identifiers correspond to respective release times of the pieces of the content. Apparently, it should be understood that the pieces of content may be ordered according to other information in the content of the content queue in other implementations of the present disclosure. Examples include respective amounts of page views or respective numbers of replies about the pieces of content, etc., to obtain different types of content queues according to user needs.

In addition, it should be understood that the ordering may be in ascending or descending order according to user requirements.

At S204, the server selects M pieces of content from the ordered content queue, and extracts respective identifiers of the selected M pieces of content for sending to the client. It can be understood that the first or last M pieces of content in the cached content of the ordered content queue may be selected, or the first or last M pieces of content in the content queue in a certain range may be selected according to needs in various implementations of the present disclosure.

The process ends thereafter.

Extraction of a minimal amount of identification information from content of a content queue and caching this information in a client can assist a server in sharing resource pressure.

S101 may also have other implementations. For example, a request from the client may not be needed in some scenarios, and the server may directly push identifiers of M pieces of content in a content queue to the client.

A second embodiment of the present disclosure is related to a content caching and transmission method. The second embodiment includes variations or additions from the first embodiment.

In implementations, the method may further include the following method blocks.

The server obtains the content queue, and sends identifiers of L pieces of new content in the content queue to the client when the client needs to display content other than the M pieces of content, where L is a predefined integer. It can be understood that L may also be selected by the client, so that content may be returned according to actual needs.

The client caches the received L identifiers for display of the new page.

The foregoing method is described in detail hereinafter using Timeline and APP. The Timeline corresponds to dynamic streams or content streams of the accounts that are followed by the user and that are ordered according to conditions such as time and displayed in a stream-like form after integration, which also supports scrolling down of pages. The Timeline normally displays hundreds of pieces of content at most, and each page only display tens of pieces of content in general. In other words, the client may only obtain tens of pieces of content data as a single page of the Timeline each time the client submits a request to the server. If a user continues to scroll down to browse more Timeline data, the client sends a request to the server to obtain data of a next page, and this operation is scroll-down.

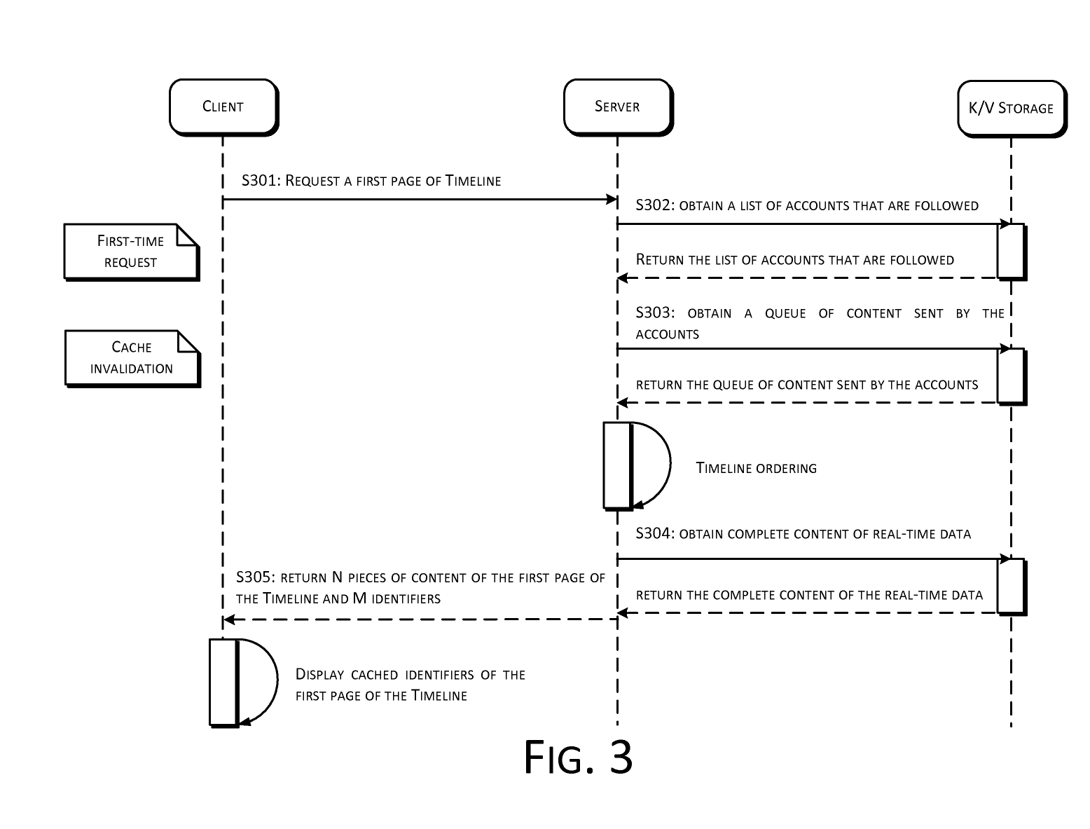

FIG. 3 is a flowchart illustrating interactions between a client and a server when making a request for the first time or in an event of cache invalidation. As shown in FIG. 3, when the client requests a first page of Timeline or in an event of cache invalidation at S301, the server obtains cached data of all accounts that the user follows from a K/V storage at S302, selects M pieces of content according to ordered identifiers at S303, selects N pieces of content of the first page to form Timeline data for returning to the client at S304, and also returns a maximum number of M identifiers to be displayed at S305. It should be understood that M is not limited to the maximum number of content to be displayed in the content queue, and may also be other predefined integers. In addition, it can be understood that, the server may also send the M identifiers to the client at any other time, which is not limited to the time that the request is firstly made or the time when the cache is invalidated, in other implementations of the present disclosure.

The M identifiers cached in the APP of the client are invalidated in situations as follows:
refresh: click a key or obtain the latest Timeline;
data change: a user adds or delete a new account to follow; and
logout: isolation between identification information of A and B needs to be ensured when a currently-logged-in user A logs out of an account, and then logs in using another account B; or identification information of a user is deleted after that user logs out.

It should be understood that any situation that causes the M identifiers to change will result in cache invalidation, in addition to the aforementioned situations.

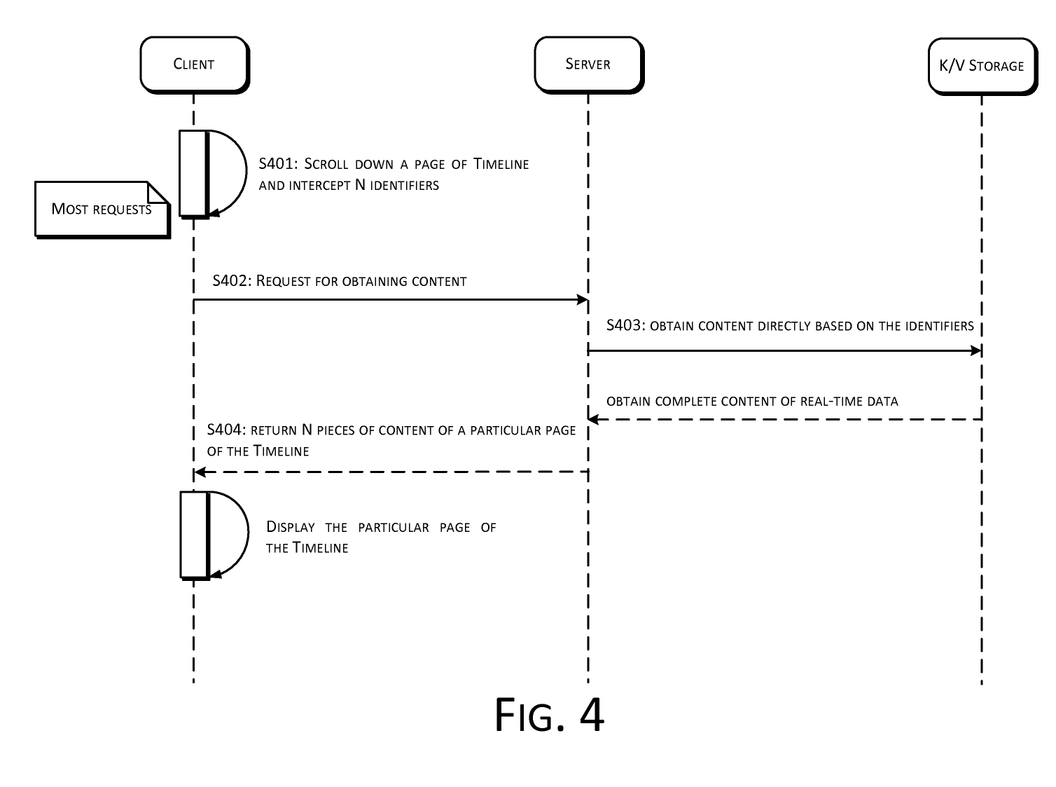

FIG. 4 is a flowchart illustrating interactions between a client and a server for most requests. As shown in FIG. 4, when scrolling down of the Timeline is desired, the client intercepts N identifiers of a next page from identifiers cached by the APP based on information of the last piece of content of a current page at S401, and requests the server to return data corresponding to the N identifiers at S402. The server directly obtains N pieces of content from a K/V storage according to the identifiers to form a Timeline content queue at S403 and return N pieces of content to the client at S404. Most scroll-down requests may be returned in this manner, and the server does not need to obtain all data, and order and return the data in each time. It can be understood that the N identifiers may be intercepted based on the first piece of content or any piece of content in a current page when scrolling down the page in other implementations of the present disclosure.

As can be intuitively seen from a comparison between the processes of FIG. 3 and FIG. 4, most Timelines that are optimized in this solution are exempted from the processes from “obtaining a list of accounts that are followed” to “ordering Timelines” in FIG. 3, thereby saving intranet traffic, computing and storage resources.

The Timeline and the APP as described above are merely examples, and the content caching and transmission method may also be applied to other types of content queues and clients, and corresponding adjustment may be made on certain method blocks according to needs, which are not limited to the aforementioned process that the Timelines are cached and transmitted on the APP.

The method embodiments of the present disclosure may be implemented in a form of software, hardware, firmware, etc. Whether the present disclosure is implemented in a form of software, hardware or firmware, an instruction code may be stored in any type of computer accessible storage device (e.g. permanent or modifiable, volatile or non-volatile, solid or non-solid, fixed or interchangeable media, etc.). Furthermore, the storage device may be, for example, programmable array logic (“PAL”), random access memory (“RAM”), programmable read only memory (“PROM”), read-only memory (“ROM”), electrically erasable programmable ROM (“EEPROM”), a magnetic disk, an optical disc, a digital versatile disc (“DVD”), etc.

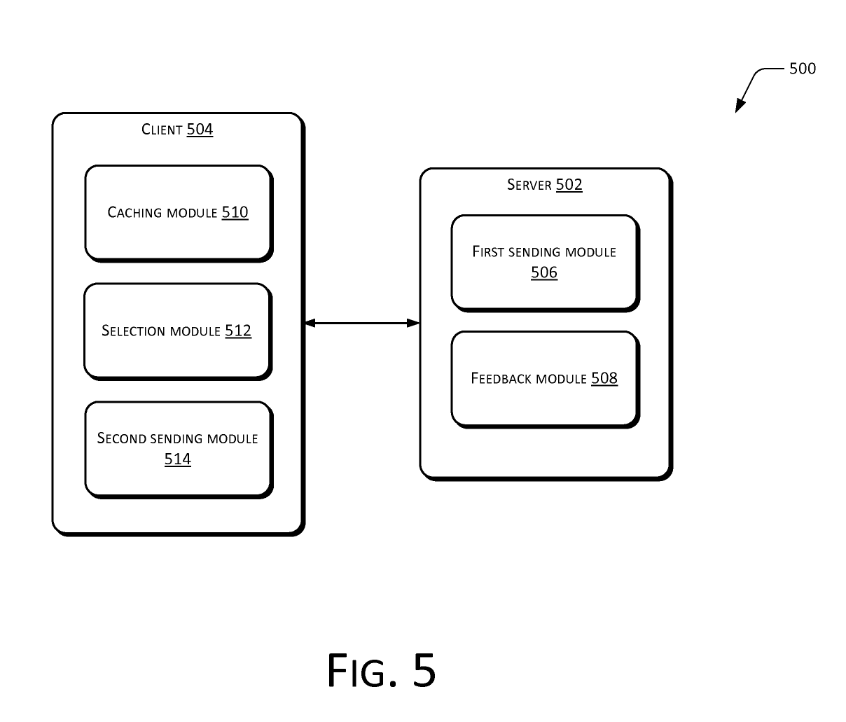

A third embodiment of the present disclosure is related to a content caching and transmission system. FIG. 5 is a structural diagram of the content caching and transmission system 500. A content queue includes at least one piece of content, each piece of content includes an identifier and a value, and the identifier is unique in the content queue. As shown in FIG. 5, the system 500 includes a server 502 and a client 504.

In implementations, the server 502 may include a first sending module 506 configured to obtain a content queue, and send identifiers of M pieces of content in the content queue to the client 504, M being a predefined integer; and a feedback module 508 configured to obtain corresponding N pieces of new content based on N identifiers received from the client 504, and return the corresponding N pieces of new content to the client 504 for display.

As an alternative implementation, the first sending module 506 of the server 502 may obtain the content queue when the client 504 requests content of the content queue for the first time or in an event of cache invalidation, and sends identifiers of M pieces of content in the content queue to the client 504. In implementations, the cache invalidation may include situations such as the client 504 updating the M pieces of content, changing a user account, or altering all accounts that are followed.

The client 504 may include a caching module 510 configured to cache the M identifiers received from the server 502; a selection module 512 configured to select the N identifiers from the cached M identifiers when a new page of the N pieces of new content is to be displayed, where N<M; and a second sending module 514 configured to send the selected N identifiers to the server 502.

In this system embodiment, a client only needs to return corresponding identifiers cached by the client to a server when a new page needs to be displayed. The server may directly obtain content of a content queue based on the identifiers for the client to display without the need of ordering and computation repeatedly, thus saving transmission and caching resources, reducing data transmitted between the client and the server, improving user experience in terms of browsing speed, and facilitating expansion in response to an increase in the number of users.

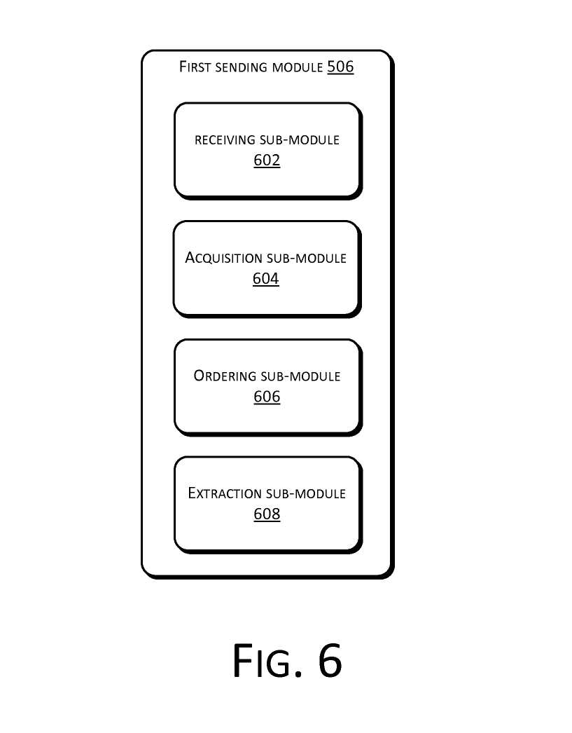

As shown in FIG. 6, the first sending module 506 of the server 502 may include the following sub-modules:

a receiving sub-module 602 configured to receive a request from the client 504;

an acquisition sub-module 604 configured to obtain a content queue according to the request of the client 504, the content queue including content of all accounts that the client 504 follows;

an ordering sub-module 606 configured to order the content in the content queue according to respective identifiers; and

an extraction sub-module 608 configured to select M pieces of content from the ordered content queue, and extract corresponding identifiers of the selected M pieces of content for send to the client 504.

In implementations, the identifiers correspond to respective release times of the pieces of the content. Apparently, it can be understood that the pieces of content may be ordered according to other information in the content of the content queue in other implementations of the present disclosure. Examples include respective amounts of page views or respective numbers of replies about the pieces of content, etc., to obtain different types of content queues according to user needs.

The content caching and transmission system extracts a minimal amount of identification information from content of a content queue and caching this information in a client can assist a server in sharing resource pressure.

The first embodiment is a method implementation corresponding to the present embodiment, and the present embodiment can be implemented in combination with the first embodiment. The related technical details described in the first embodiment are still effective in the present embodiment, which are not repeatedly described herein to avoid redundancy. Correspondingly, the related technical details described in the present embodiment are also applicable to the first embodiment.

A fourth embodiment of the present disclosure is related to a content caching and transmission system. The fourth embodiment includes a number of changes or additions from the third embodiment.

The first sending module 506 of the server 502 is further configured to obtain the content queue and send identifiers of L pieces of new content in the content queue to the client 504 when the client 504 needs to display content other than the M pieces of content, where L is a predefined integer. It can be understood that L may also be selected by the client 504, so that corresponding content may be returned according to actual needs. The caching module 510 of the client 504 is further configured to cache the received L identifiers for displaying the new page.

The second embodiment is a method implementation corresponding to the present embodiment, and the present embodiment can be implemented in combination with the second embodiment. The related technical details described in the second embodiment are still effective in the present embodiment, which are not repeatedly described herein to avoid redundancy. Correspondingly, the related technical details described in the present embodiment are also applicable to the second embodiment.

A fifth embodiment of the present disclosure is related to a content caching and transmission method. FIG. 1 is a flowchart of the content caching and transmission method. A content queue includes at least one piece of content, each piece of content includes an identifier and a value, and the identifier is unique in the content queue. As shown in FIG. 1, the method may include the following method blocks:

At S101, a server obtains a content queue, and sends identifiers of M pieces of content in the content queue to a client, so that the client may cache the received M identifiers (at S102) select N identifiers from the cached M identifiers when a new page of N pieces of new content is to be displayed (at S103), and send the selected N identifiers to the server (at S104), where M is a predefined integer, and N<M.

At S105, the server obtains the corresponding N pieces of new content according to the received N identifiers, and returns the corresponding N pieces of new content to the client for display.

Afterwards, the process ends.

The present embodiment corresponds to a method implementation of the first embodiment or the second embodiment that is implemented at a server, and the present embodiment can be implemented in combination with the first embodiment or the second embodiment. The related technical details mentioned in the first embodiment or the second embodiment are still effective in the present embodiment, which are not repeatedly described herein to avoid redundancy. Correspondingly, the related technical details mentioned in the present embodiment are also applicable to the first embodiment or the second embodiment.

A sixth embodiment of the present disclosure is related to a content caching and transmission method. FIG. 1 is a flowchart of the content caching and transmission method. A content queue includes at least one piece of content, each piece of content includes an identifier and a value, and the identifier is unique in the content queue. As shown in FIG. 1, the method may include the following method blocks:

At S102, the client receives and caches M identifiers of M pieces of content in a content queue obtained by the server from the server, M being a predefined integer.

At S103, the client selects N identifiers from the cached M identifiers when a new page of N pieces of new content is to be displayed, where N<M.

At S104, the client sends the selected N identifiers to the server for the server to obtain the corresponding N pieces of new content according to the received N identifiers and return the corresponding N pieces of new content to the client for display.

Afterwards, the process ends.

The present embodiment corresponds to a method implementation of the first embodiment or the second embodiment that is implemented at a client, and the present embodiment can be implemented in combination with the first embodiment or the second embodiment. The related technical details mentioned in the first embodiment or the second embodiment are still effective in the present embodiment, which are not repeatedly described herein to avoid redundancy. Correspondingly, the related technical details mentioned in the present embodiment are also applicable to the first embodiment or the second embodiment.

A seventh embodiment of the present disclosure is related to a content caching and transmission system. FIG. 5 is the structural diagram of the content caching and transmission system 500. A content queue includes at least one piece of content, each piece of content includes an identifier and a value, and the identifier is unique in the content queue. The system 500 includes the server 502.

As shown in FIG. 5, the server 502 includes the first sending module 506 configured to obtain a content queue, and send identifiers of M pieces of content in the content queue to a client 504 for the client 504 to cache received M identifiers, select N identifiers from the cached M identifiers when a new page of N pieces of new content needs to be displayed, and send the selected N identifiers to the server 502, where M is a predefined integer, and N<M; and the feedback module 508 configured to obtain the corresponding N pieces of new content according to the N identifiers received from the client 504, and return the corresponding N pieces of new content to the client 504 for display.

The fifth embodiment is a method implementation corresponding to the present embodiment, and the present embodiment can be implemented in combination with the fifth embodiment. The related technical details described in the fifth embodiment are still effective in the present embodiment, which are not repeatedly described herein to avoid redundancy. Correspondingly, the related technical details described in the present embodiment are also applicable to the fifth embodiment.

An eighth embodiment of the present disclosure is related to a content caching and transmission system. FIG. 5 is the structural diagram of the content caching and transmission system 500. A content queue includes at least one piece of content, each piece of content includes an identifier and a value, and the identifier is unique in the content queue. The system 500 includes the client 504.

As shown in FIG. 5, the client 504 includes the caching module 510 configured to receive and cache M identifiers of M pieces of content in a content queue obtained by the server 502 from the server 502, M being a predefined integer; the selection module 512 configured to select N identifiers from the cached M identifiers when a new page of N pieces of new content is to be displayed, where N<M; and the second sending module 514 configured to send the selected N identifiers to the server 502 for the server 502 to obtain the corresponding N pieces of new content according to the received N identifiers and return the corresponding N pieces of new content to the client 504 for display.

The sixth embodiment is a method implementation corresponding to the present embodiment, and the present embodiment can be implemented in combination with the fifth embodiment. The related technical details described in the sixth embodiment are still effective in the present embodiment, which are not repeatedly described herein to avoid redundancy. Correspondingly, the related technical details described in the present embodiment are also applicable to the sixth embodiment.

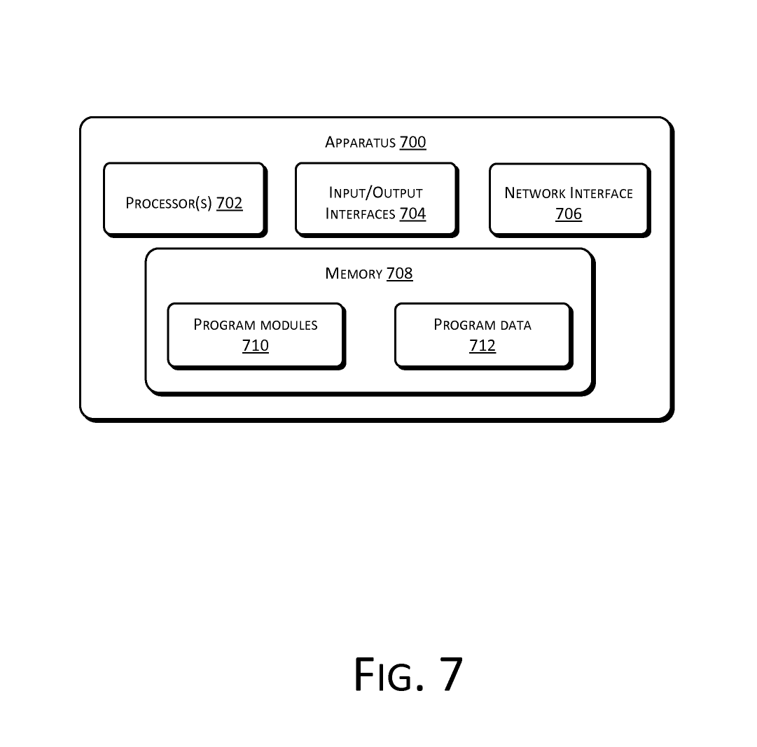

FIG. 7 shows an example apparatus 700, such as the system 500, the server 502 and the client 504 as described in FIGS. 3-5 in further detail. In implementations, the apparatus 700 may include one or more computing devices. In implementations, the apparatus 700 may include, but is not limited to, one or more processors 702, an input/output interface 704, a network interface 706, and memory 708.

The memory 708 may include a form of computer readable media, e.g., a non-permanent storage device, random-access memory (RAM) and/or a nonvolatile internal storage, such as read-only memory (ROM) or flash RAM. The memory 708 is an example of computer readable media.

The computer readable media may include a permanent or non-permanent type, a removable or non-removable media, which may achieve storage of information using any method or technology. The information may include a computer-readable command, a data structure, a program module or other data. Examples of computer storage media include, but not limited to, phase-change memory (PRAM), static random access memory (SRAM), dynamic random access memory (DRAM), other types of random-access memory (RAM), read-only memory (ROM), electronically erasable programmable read-only memory (EEPROM), quick flash memory or other internal storage technology, compact disk read-only memory (CD-ROM), digital versatile disc (DVD) or other optical storage, magnetic cassette tape, magnetic disk storage or other magnetic storage devices, or any other non-transmission media, which may be used to store information that may be accessed by a computing device. As defined herein, the computer readable media does not include transitory media, such as modulated data signals and carrier waves.

The memory 708 may include program modules 710 and program data 712. Depending on which system, server or client that the apparatus 700 corresponds or refers to, the program modules 710 may include one or more modules, circuits and/or components, etc., as described above. Details of these modules, circuits and/or components can be found in the foregoing description and are therefore not redundantly described herein.

In short, the content caching and transmission methods and the systems thereof of the present disclosure have the following advantages:

(1) A minimal data volume of identification information is extracted from a large data volume of personalized data that is conventionally cached in a server, and is creatively cached in a client of each logged-in user.

(2) A client is clearly aware of data that is missing, and submits a request to a server for obtaining thereof, thus reducing data transmitted between the client and the server.

(3) The intranet traffic, storage and computing pressures on a server are significantly reduced, thus facilitating expansion in response to a trend of an increasing number of users.

(4) User experience related to the speed of browsing a new page is enhanced greatly.

It should be noted that various modules described in the apparatus implementations of the present disclosure are logical modules. Physically, a logical module may be a physical module, or a component of a physical module, and may be implemented with a combination of a plurality of physical modules. Physical implementations of these logical modules per se are not the most important, but a combination of functions implemented by these logical modules is a key to solving the technical problems that are set forth in the present disclosure. In addition, in order to highlight the innovative parts of the present disclosure, the apparatus implementations of the present disclosure do not introduce module(s) that is/are not closely associated with the technical problems set forth in the present disclosure, which however does not indicate that the apparatus implementations do not have other modules.

It should be noted that relational terms described herein, such as “first” and “second”, etc., are used solely to distinguish one entity or operation from another entity or operation without necessarily requiring or implying any existence of such relationship or ordering between these entities or operations in reality. Moreover, terms such as “comprise”, “include” and any other variants thereof are intended to cover a non-exclusive inclusion. A process, method, product or device that includes a series of elements not only includes those elements, but also includes other elements that are not explicitly listed, or further includes elements that already existed in such process, method, product or device. In a condition without further limitations, an element defined by a phrase “include a/an . . . ” does not exclude any other similar elements from existing in the process, method, product or device.

Although the present disclosure has been illustrated and described using certain exemplary embodiments of the present disclosure, one of ordinary skill in the art should understand that various changes may be made to the forms and details of these embodiments without departing from the spirit and scope of the present disclosure.

What is claimed is:

1. A method implemented by one or more computing devices, the method comprising:
obtaining a content queue including a plurality of pieces of content;
sending identifiers of M pieces of content included in the content queue to a client to cause the client to store the identifiers of the M pieces of content, M being a predefined integer;
receiving N identifiers from the client, the N identifiers being selected by the client in response to a new page of N pieces of new content to be displayed in the client, with N<M;
obtaining the N pieces of new content based at least in part on the received N identifiers; and
returning the N pieces of new content to the client for display.

2. The method of claim 1, further comprising:
receiving a request from the client; and
obtaining the content queue according to the request of the client, wherein the plurality of pieces of content comprising content of accounts that a user of the client follows.

3. The method of claim 1, further comprising:
ordering the plurality of pieces of content in the content queue according to respective identifiers of the plurality of pieces of content;
selecting the M pieces of content from the ordered content queue; and
extracting the identifiers of the M pieces of content for sending to the client.

4. The method of claim 3, wherein the respective identifiers comprise corresponding release times of the plurality of pieces of content.

5. The method of claim 1, further comprising sending identifiers of L pieces of new content in the content queue to the client to cause the client to store the identifiers of the L pieces of new content for the client to display content other than the M pieces of content, L being an integer greater than or equal to one.

6. The method of claim 1, wherein obtaining the content queue is performed in response to the client requesting content of the content queue for a first time or in an event of cache invalidation.

7. The method of claim 6, wherein the cache invalidation comprises one or more of the client updating the M pieces of content, the client changing a user account, or the client altering one or more accounts that a user of the client follows.

8. The method of claim 1, wherein the content queue comprises at least one piece of content, each piece of content comprises a respective identifier and a respective value, and the respective identifier is unique in the content queue.

9. One or more computer-readable media storing executable instructions that, when executed by one or more processors, cause the one or more processors to perform acts comprising:
obtaining a content queue, and sending identifiers of M pieces of content in the content queue to a client to enable the client to store the identifiers of the M pieces of content and select N identifiers from the M identifiers prior to displaying a new page of N pieces of new content, with N<M;
receiving the N identifiers from the client; and
obtaining the N pieces of new content according to the received N identifiers, and returning the N pieces of new content to the client for display.

10. The one or more computer-readable media of claim 9, the acts further comprising:
receiving a request from the client; and
obtaining the content queue according to the request of the client side, wherein the content queue comprises multiple pieces of content of one or more accounts that a user of the client follows.

11. The one or more computer-readable media of claim 10, the acts further comprising:
ordering the multiple pieces of content of the one or more accounts in the content queue according to respective identifiers of the multiple pieces of content;
selecting the M pieces of content from the ordered content queue; and
extracting the identifiers of the M pieces of content for sending to the client.

12. The one or more computer-readable media of claim 11, wherein the identifiers of the M pieces of content comprise respective release times of the M pieces of content.

13. The one or more computer-readable media of claim 9, the acts further comprising sending identifiers of L pieces of new content in the content queue to the client to cause the client to store the identifiers of the L pieces of new content for the client to display content other than the M pieces of content, L being an integer greater than or equal to one.

14. The one or more computer-readable media of claim 9, wherein obtaining the content queue is performed in response to the client requesting content of the content queue for a first time or in an event of cache invalidation.

15. The one or more computer-readable media of claim 14, wherein the cache invalidation comprises one or more of the client updating the M pieces of content, the client changing a user account, or the client altering one or more accounts that a user of the client follows.

16. The one or more computer-readable media of claim 9, wherein the content queue comprises at least one piece of content, each piece of content comprises a respective identifier and a respective value, and the respective identifier is unique in the content queue.

17. An apparatus comprising:
one or more processors;
memory;
a first sending module stored in the memory and executable by the one or more processors to obtain a content queue, and send identifiers of M pieces of content in the content queue to a client to enable the client to store the identifiers of the M pieces of content and select N identifiers from the M identifiers prior to displaying a new page of N pieces of new content, with N<M; and
a feedback module to receive the N identifiers from the client, obtain the N pieces of new content according to the received N identifiers, and return the N pieces of new content to the client for display.

18. The apparatus of claim 17, wherein the first sending module comprises:
a receiving sub-module configured to receive a request from the client;
an acquisition sub-module configured to obtain the content queue according to the request of the client, the content queue comprising a plurality of pieces of content of one or more accounts that a user of the client follows;
a ranking sub-module configured to order the plurality of pieces of content in the content queue according to respective identifiers of the plurality of pieces of content; and
an extraction sub-module configured to select the M pieces of content from the ordered content queue, and extract the identifiers of the M pieces of content for sending to the client.

19. The apparatus of claim 18, wherein the respective identifiers comprises respective release times of the plurality of pieces of content.

20. The apparatus of claim 17, wherein the first sending module obtains the content queue in response to the client requesting content of the content queue for a first time or in an event of cache invalidation, wherein the cache invalidation comprises one or more of the client updating the M pieces of content, the client changing a user account, or the client altering one or more accounts that a user of the client follows.
